(19) United States
(12) Patent Application Publication
(10) Pub. No.: US 2025/0088048 A1
(43) Pub. Date: Mar. 13, 2025

(54) Stator for an Electric Machine, Electric Machine and Motor Vehicle

(71) Applicant: Bayerische Motoren Werke Aktiengesellschaft, Muenchen (DE)

(72) Inventors: Jochen KRONSTEINER, St. Ulrich bei Steyr (AT); Andreas Wagner, St. Valentin (AT)

(21) Appl. No.: 18/830,689

(22) Filed: Sep. 11, 2024

(30) Foreign Application Priority Data
Sep. 12, 2023 (DE) 10 2023 124 497.3

(51) Int. Cl. H02K 1/16; H02K 3/24

(52) U.S. Cl. CPC H02K 1/16; H02K 3/24

(57) ABSTRACT

A stator for an electric machine includes a stator body having a large number of stator grooves, wherein, in each stator groove in the radial direction, a plurality of conductors are arranged one above the other. A plurality of spacing elements are configured to maintain a predetermined spacing between the conductors and a spacing of the respective conductors from a groove wall of the stator body, wherein, within the stator groove, respective cooling channels, which are at least partially delimited by the respective conductors, are kept free, whereby a cooling fluid can flow directly along the conductors, wherein each of the conductors has in the cross section thereof an angular form, and each of the corners of the angular form is supported by a respective spacing element against an additional conductor and/or the groove wall.

### CROSS REFERENCE TO RELATED APPLICATION

This application claims priority under 35 U.S.C. § 119 from German Patent Application No. DE 10 2023 124 497.3, filed Sep. 12, 2023, the entire disclosure of which is herein expressly incorporated by reference.

### BACKGROUND AND SUMMARY

The present disclosure relates to a stator for an electric machine, an electric machine having a stator and a motor vehicle having an electric machine.

DE 10 2021 133 992 A1 discloses a stator for an electric machine, comprising a stator body, having a large number of stator teeth which are arranged in a state distributed over the circumference and stator grooves which are formed between the stator teeth and which extend in an axial direction through the stator. Electrical conductors of a stator winding which are arranged substantially radially one above the other are received in the stator grooves. The stator grooves have along the radial extent thereof at the radially outer end thereof a groove base and at the radially inner end thereof a groove opening. In this instance, the groove openings are in each case closed by a groove closure means. The stator grooves are in each case separated from the stator windings by an insulation means, wherein the insulation means and the groove closure means are formed in an integral, in particular monolithic manner with each other. At least one of the insulation means may have a spacing element which protrudes into the respective stator groove and which spaces an electrical conductor from the insulation means with a through-flowable channel being formed.

WO 2022/188916 A1 further discloses a stator for an electric machine, comprising a stator body having a large number of stator teeth which are arranged in a state distributed over the circumference and stator grooves which are formed between the stator teeth and which extend in an axial direction through the stator. There are received in the stator grooves stator windings which are arranged radially one above the other and which are each surrounded by an insulation. The insulation bears at least partially against a stator groove. The insulation has a face which is rectangular in cross section. The design of the insulation has abutment portions at the four corners of the rectangular basic cross section of the shaft winding which together with a covering face of the stator grooves form cooling channels for a direct groove cooling.

An object of the present disclosure is to provide a solution which enables a direct groove cooling of conductors that are arranged in a stator groove and that enables oscillations of the conductors in the stator groove to be able to be limited.

This object is achieved according the aspects of subject-matter of the present disclosure. Other possible embodiments are disclosed in the claims, the description, and the FIGURES. Features, advantages, and possible embodiments which are set out in the context of the description for one of the aspects of subject-matter of the independent claims may be considered at least in a similar manner as features, advantages and possible embodiments of the respective subject-matter of the other independent claims and each possible combination of the aspects of subject-matter of the independent claims, where applicable in connection with one or more of the dependent claims.

The present disclosure relates to a stator for an electric machine, in particular a traction machine of a motor vehicle. The traction machine is in particular configured to drive the motor vehicle by electrical energy from a vehicle battery. In addition, the electric machine has a rotor which during operation is rotated relative to the stator about a rotation axis. In particular, the stator is configured to be used in a radial flux machine. The stator comprises a stator body which may in particular comprise a large number of stator laminations which are stacked one on the other in a stack direction and may consequently be in the form of a laminated core. In this instance, the stack direction of the stator laminations extends in particular parallel with the rotation axis of the rotor of the electric machine for which the stator is provided.

The stator body has a large number of stator grooves which are arranged in a state distributed in the circumferential direction about a center axis of the stator. These stator grooves extend in particular over the entire axial length of the stator, wherein the axial length extends parallel with the stack direction or parallel with the rotation axis of the rotor or parallel with a center axis of the stator. With respect to the radial direction, which is perpendicular with respect to the axial direction, of the stator, the stator grooves extend in particular in a star-like manner starting from the center axis of the stator into the stator body. In each stator groove, in the radial direction which extends perpendicularly to the center axis a plurality of conductors are arranged one above the other. These conductors may in particular be so-called hairpins. The conductors may in particular be in the form of copper wires.

The stator further comprises a plurality of spacing elements which are configured to maintain a predetermined spacing in the radial direction between the conductors and a spacing of the respective conductors from a groove wall, which delimits the associated stator groove, of the stator body. The respective spacing elements are configured separately from the conductors. Consequently, the spacing elements are not components of an insulation of the respective conductors. In particular, the respective spacing elements bear in each case on at least one of the conductors in order to position this conductor or to maintain the spacing of this conductor with respect to another conductor and/or the groove wall. As a result of the maintenance of the respective spacings, respective cooling channels, through which a cooling fluid can flow within the stator groove, and which are delimited at least partially by the respective conductors, are kept free. As a result of the fact that the cooling channels are at least partially limited by the respective conductors, the cooling fluid flows during correct use of the stator directly along the conductors. The cooling fluid is configured in order to cool the respective conductors to absorb heat from the respective conductor. It is thus possible to achieve a direct cooling of the respective conductors by the cooling fluid when the cooling fluid flows through the respective cooling channels. The respective conductors can thereby be cooled in a particularly efficient manner.

In the stator there is further provision for each of the conductors to have in its cross section which extends perpendicularly to the center axis an angular form, in particular a rectangular form. There is further provision for each of the corners of the rectangular form of all the conductors to be supported by a respective spacing element against a conductor and/or the groove wall. This means that each corner of each conductor is supported in the stator groove by an associated spacing element. An oscillation of the respective conductors within the stator groove can thereby be limited in a particularly effective manner. Furthermore, the respective conductors can be particularly well positioned in the respective stator grooves by the associated spacing elements.

In one possible development of the present disclosure, there is provision for the conductors to be clamped by the spacing elements in the respective stator grooves. This means that the spacing elements are configured to press the conductors in the associated stator groove. To this end, the respective spacing elements may have an excess dimension and can for the clamping of the respective conductors in the stator groove be at least partially compressed. A secure retention of the respective conductors at the positions which are fixedly predetermined for the respective conductors within the stator groove can thereby be ensured.

In another possible embodiment of the present disclosure, there is provision for at least one of the spacing elements to close a groove opening of the associated stator groove radially inwardly toward the center axis. This means that at least one of the spacing elements is at least partially in the form of a groove closure wedge, whereby by the region of this spacing element which are in the form of a groove closure wedge the groove opening of this stator groove can be reliably closed inwardly toward the center axis. A discharge of cooling fluid which is guided in the stator groove, in particular cooling fluid guided in the cooling channels, via the groove opening out of the stator groove can thereby be limited, in particular be avoided. The guiding of the cooling fluid can consequently be particularly well limited to the cooling channels in the stator groove. Any risk of a leakage of the cooling fluid via the groove opening can consequently be kept particularly low. It can thereby be ensured as a result of the prevented leakage that sufficient cooling fluid can flow through each of the cooling channels during operation. An efficient and defined cooling of the respective conductors in the stator groove can thereby again be ensured by the cooling fluid flowing in the cooling channels.

In this context, there may in particular be provision for the spacing element which closes the groove opening to have a U-shape. In this instance, each of the legs of the U-shape is placed on a corner of the angular cross section and consequently an edge of the conductor in this stator groove, which conductor has in the radial direction the smallest spacing with respect to the center axis of the stator. This means that the legs of the U-shape of the spacing element are placed against the innermost conductor with respect to the radial direction in this stator groove. An inner side, which faces this conductor and which forms the base of the recess of the U-shape, of the spacing element delimits together with the conductor a cooling channel. This cooling channel covers the radially innermost conductor in this stator groove partially in a radial direction toward the center axis. In this instance, the inner side of the spacing element faces the side face of the radially innermost conductor which is arranged facing the center axis of the stator. In other words, the spacing element which closes the groove opening delimits together with the radially innermost conductor in this stator groove one of the cooling channels, whereby by the cooling fluid which flows through this cooling channel the radially innermost conductor can be cooled in a particularly efficient manner at the side face thereof facing the center axis.

In another possible embodiment of the present disclosure, there is provision for at least one of the spacing elements to be configured to support two corners of the respective cross sectional shape of two different conductors with respect to each other and against the groove wall. To this end, this spacing element can in particular be arranged in a radial direction between the respective conductors which are intended to be supported. It is thereby possible for a first edge, which is arranged further radially outward and which bears radially from the outer side on the spacing element, of a first conductor, and a radially inner edge, which bears radially from the inner side on the spacing element, of a second conductor to be supported with respect to each other by this spacing element. In addition, this spacing element bears in a circumferential direction which extends about the center axis on the groove wall, whereby the two corners of the respective angular cross sections of these different conductors are supported against the groove wall. This means that by this spacing element the position of the respective corners of the cross sections of the different conductors both with respect to each other and with respect to the groove wall is precisely predetermined. The spacing element, which is arranged in a radial direction between the conductors which are arranged in a common stator groove, supports these different conductors which are adjacent to each other in a radial direction at corners of the cross section thereof which face each other in a radial direction, wherein these corners which are supported by the spacing element are arranged facing each other in a circumferential direction of the same groove wall of the stator groove. As a result of the fact that by this at least one spacing element two edges of two different conductors are supported together, the stator can be configured with particularly few spacing elements and consequently in a particularly simple and particularly lightweight manner by all the corners of the cross section of all the conductors being supported within a stator groove using a particularly small number of spacing elements.

In another possible embodiment of the present disclosure, there is provision for each side face of each conductor to partially delimit at least one cooling channel. It may thereby be possible during operation for each side face of each conductor to be flowed against by cooling fluid flowing in the respective cooling channel and thereby to be cooled. Consequently, a particularly uniform and reliable cooling of each of the conductors arranged in the stator groove can thereby be achieved.

In another possible embodiment of the present disclosure, there is provision for each of the groove walls which delimit the stator groove to be insulated with a groove insulation. This groove insulation may also be referred to as a so-called groove base insulation. This groove insulation serves to electrically insulate the laminated core with respect to the conductors. Furthermore, the groove insulation serves to mechanically protect the conductors against sharp edges of the stator body. The groove insulation may, for example, be in the form of paper insulation.

The present disclosure further relates to an electric machine, having a stator as has been described above in connection with the stator according to the present disclosure. The electric machine is in particular a traction machine for an electric motor vehicle. The electric machine is configured to drive the motor vehicle.

The present disclosure further relates to a motor vehicle having an electric machine as has been described above in connection with the electric machine according to the present disclosure. The electric machine is configured to drive the motor vehicle using electrical energy.

Other features of the present disclosure can be derived from the claims, the Figures and the description of the FIGURES. The features and feature combinations mentioned above in the description and the features and feature combinations set out below in the description of the Figures and/or in the FIGURES alone can be used not only in the combination set out in each case but also in other combinations or alone without departing from the scope of the present disclosure.

Other objects, advantages and novel features of the present disclosure will become apparent from the following detailed description of one or more preferred embodiments when considered in conjunction with the accompanying drawings.

### BRIEF DESCRIPTION OF THE DRAWING

FIG. 1 shows a schematic sectioned view of a stator groove of a stator in which a plurality of conductors are arranged in a state stacked one above the other in a radial direction.

### DETAILED DESCRIPTION OF THE DRAWING

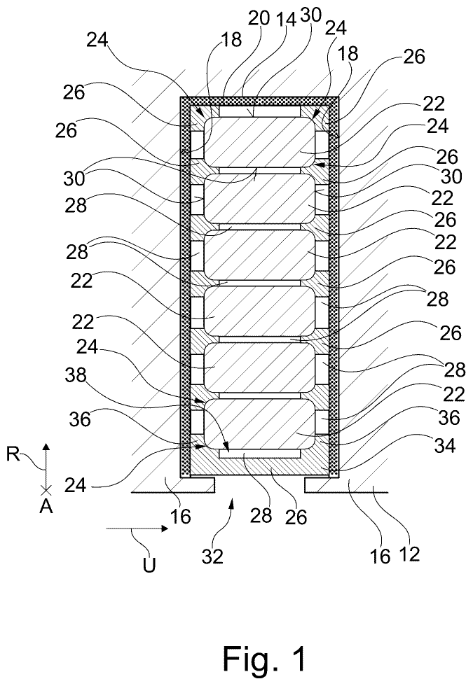

In FIG. 1, a stator 10 for an electric machine of a motor vehicle is shown as a sectioned cut-out. The stator 10 comprises a stator body 12 which in this instance is in the form of a laminated core. The stator body 12 has an at least substantially hollow-cylindrical geometry, wherein the stator body 12 is configured at least substantially symmetrically with respect to a center axis of the stator 10. An axial direction A of the stator 10 extends in a longitudinal extent direction of the center axis of the stator 10. A radial direction R of the stator 10 is perpendicular to the axial direction A. In the illustration shown in FIG. 1, the axial direction A extends into the image plane. A circumferential direction U of the stator 10 extends about the center axis of the stator 10.

The stator body 12 has a large number of stator grooves 14 which are arranged in a state distributed in the circumferential direction U about the center axis of the stator 10. The stator grooves 14 extend in particular over the entire length, which extends in the axial direction A, of the stator body 12 and in the radial direction R from the center of the stator 10 into the stator body 12. Respective stator grooves 14 which are adjacent to each other in the circumferential direction U are delimited from each other by a stator tooth 16 which is arranged in each case in the circumferential direction U between these stator grooves 14. In this instance, an outer side of this stator tooth 16 forms a groove wall 18 which delimits the respective stator groove 14. As can be seen in FIG. 1, in the shown stator groove 14 there is arranged a groove insulation 20 which bears on the groove walls 18 which delimit this stator groove 14. The respective groove walls 18 are thereby insulated by the groove insulation 20.

As can be further seen in FIG. 1, in the stator groove 14 a plurality of conductors 22 are arranged beside each other in a radial direction R. In the cross section which is shown in FIG. 1 and which extends perpendicularly to the axial direction A, the respective conductors 22 have at least substantially a rectangular cross section. This means that the cross section of the respective conductors 11 has at least substantially four corners 24. For reasons of clarity, only some of the corners 24 of the respective conductors 22 are provided with the associated reference numeral. In order, on the one hand, to enable particularly good cooling of the respective conductors 22 in the stator groove 12 and further to be able to limit oscillations of the conductors 22 in the stator groove 14 in a particularly effective manner, there is provision for the stator 10 to comprise a plurality of spacing elements 26. A spacing element 26 bears on each corner 24 of each of the conductors 22. In order to be able to configure the stator 10 with a particularly small number of spacing elements 26, there is provision in this instance for some of the spacing elements 26 to bear on mutually facing corners 24 in a radial direction R of the cross section of conductors 22 which are directly adjacent to each other in a radial direction R. This means that two corners 24 of the cross sectional shape of two different conductors 22 are supported with respect to each other by a single spacing element 26. In this instance, there is further provision for each of the spacing elements 26 to be supported against the groove wall 18 which delimits the stator groove 14. To this end, each of the spacing elements 26 bears on the groove insulation 20 which in turn bears on the respective groove walls 18. Consequently, the edges of the respective conductors 22 corresponding to the corners 24 in cross section are supported via the respective spacing elements 26 with respect to the respective groove walls 18 and where applicable in addition to respective additional corners 24 of the cross sections of additional conductors 22. Via the spacing elements 26, the conductors 22 can consequently be positioned in the stator groove 14 in a particularly precise manner. Furthermore, as a result of the support of all the corners 24 of the cross sectional shape of each conductor 22, an oscillation of the respective conductor 22 inside the stator groove 14 can be limited in a particularly effective manner. As a result of the fact that the spacing elements 26 maintain respective spacings between the conductors 22 with respect to each other and the conductors 22 with respect to the groove wall 18, in particular the groove insulation 20, respective cooling channels 28 are formed. For reasons of clarity, only some of the cooling channels 28 are provided with the associated reference numeral.

The cooling channels 28 are configured, during correct use of the stator 10 and during operation of the electric machine which has the stator 10, to be flowed through by a cooling fluid, in particular cooling oil. A direct groove cooling of the stator 10 is thereby implemented. The respective cooling channels 28 are in this instance at least partially delimited by at least one conductor 22. During operation, the cooling fluid thereby flows directly along the conductor 22 which delimits this cooling channel 28, whereby the conductor 22 can be particularly well cooled by the cooling fluid. In this instance, there is provision for each side face 30 of each conductor 22 to delimit at least one cooling channel 28. It is thereby ensured that during operation each side face 30 of each conductor 22 is cooled by being subjected to flow by the cooling fluid. For reasons of clarity, only a few of the side faces 30 of the conductors 22 are provided with the associated reference numeral.

As can be seen in FIG. 1, each stator groove 14 has a groove opening 32 at the inner end thereof facing the center axis of the stator 10. In order to prevent a discharge of the cooling fluid from the stator groove 14 via the groove opening 32, there is provision for one of the spacing elements 26 which is given the reference numeral 34 below to have a U-shaped form in cross section. This U-shaped spacing element 34 consequently acts, on the one hand, as a groove closure wedge for the groove opening 32 and, on the other hand, serves to maintain the spacing of the innermost conductor 22 relative to the center axis of the stator 10 from the respective groove walls 18. To this end, the respective legs 36 of the U-shaped cross section of the spacing element 34 bear in each case on a corner 24 of the innermost conductor 22 with respect to the radial direction R. In this instance, the legs 36 of the U-shaped cross section of the spacing element 34 bear on the innermost corners 24, with respect to the radial direction R, of the cross section of the innermost conductor 22. This innermost conductor 22 has in relation to all the conductors 22 in this common stator groove 14 the smallest spacing with respect to the center axis of the stator 10.

An inner side 38, which forms the base of the recess of the U-shaped cross section of the spacing element 34, of the spacing element 34 delimits together with this first conductor 22 one of the cooling channels 28. This cooling channel 28 covers the innermost conductor 22 partially in a radial direction R toward the center axis of the stator 10. The spacing element 34 which has the U-shaped cross section consequently enables, on the one hand, this innermost conductor 22 to be reliably stabilized at all of the corners 24 thereof, the groove opening 32 to be reliably closed and thereby sealed and, furthermore, as a result of the formation of the colling channel 28 along the side face, facing the center axis, of the innermost conductor 22, the cooling fluid to be able to flow during operation for a particularly efficient cooling of the innermost conductor 22.

In particular, there is provision for the conductors 22 to be clamped by the respective spacing elements 26 in the stator groove 14. The spacing elements 26 are combined spacing and clamping elements. The spacing elements 25 consequently perform, on the one hand, a position fixing function of the conductors 22 via the basic resilience thereof which enables a clamping of the conductors 22 in the stator groove 14, and enables the respective cooling channels 28 to be kept free. Furthermore, the spacing elements 26 enable at least substantially constant spacing to be maintained between directly mutually adjacent conductors 22 in each case and all the spacings between adjacent conductors 22 to be at least substantially identical.

The described configuration of the stator 10 enables particularly good cooling of the stator 10. This stator 10 is particularly suitable for use in the high-performance range. In the stator 10 a high thermal discharge from the thermally highly loaded conductors 22 as a result of the cooling fluid guiding in the direct vicinity of the conductors is possible. In the stator 10 oil flow spaces close to the conductors, in this instance the cooling channels 28, are provided as a result of the use of the combined spacing and clamping elements—and consequently the spacing elements 26. The spacing elements 26 are fitted at the respective corners 24 of the cross section of the conductors 22 between conductors 22 which are adjacent in each case in a radial direction R and the stator groove 14 which is provided with the groove insulation 20. As a result of the configuration of the spacing element which is innermost with respect to the radial direction R and which has the smallest spacing with respect to the center axis of the stator 10, with the U-shaped cross section, a thermal discharge close to the air gap by the cooling fluid which flows in the cooling channel 28 delimited by this spacing element 34 is enabled.

On the whole, the present disclosure shows how an oil guiding topology, close to a conductor, of an electric drive machine with direct groove cooling can be implemented.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

10 Stator
12 Stator body
14 Stator groove
16 Stator tooth
18 Groove wall
20 Groove insulation
22 Conductor
24 Corner
26 Spacing element
28 Cooling channel
30 Side face
32 Groove opening
34 Spacing element
36 Leg
38 Inner side
A Axial direction
R Radial direction
U Circumferential direction

What is claimed is:

1. A stator for an electric machine, comprising:
a stator body comprising a plurality of stator grooves that are arranged in a state distributed in a circumferential direction about a center axis of the stator,
wherein in each stator groove in a radial direction which extends perpendicularly to the center axis of the stator, a plurality of conductors are arranged one above the other, and a plurality of spacing elements are arranged and are configured to maintain a predetermined spacing in the radial direction between the plurality of conductors and a spacing of the respective conductors from a groove wall, which delimits the associated stator groove of the stator body,
wherein, within the stator groove, respective cooling channels that are configured to be flowed through by a cooling fluid, and which are at least partially delimited by the respective conductors, are kept free, whereby the cooling fluid can flow directly along the conductors,
wherein each of the conductors has in a cross section thereof, which extends perpendicularly to the center axis, an angular form, and
wherein each corner of the angular form of all the conductors is supported by a respective spacing element against an additional conductor and/or the groove wall.

2. The stator according to claim 1,
wherein the conductors are clamped by the spacing elements in the respective stator grooves.

3. The stator according to claim 1,
wherein at least one of the spacing elements closes a groove opening of the associated stator groove radially inwardly toward the center axis.

4. The stator according to claim 3,
wherein the spacing element which closes the opening has a U-shape, wherein each leg of the U-shape bears, in each case, on a corner of the cross section of the conductor in this stator groove, which conductor has in the radial direction, a smallest spacing with respect to the center axis, and wherein an inner side, which faces this conductor, of the spacing element delimits together with the conductor a cooling channel which covers the conductor partially in the radial direction toward the center axis.

5. The stator according to claim 1,
wherein at least one of the spacing elements is configured to support two corners of the cross sectional shape of two different conductors with respect to each other and against the groove wall.

6. The stator according to claim 1,
wherein each side face of each conductor partially delimits at least one cooling channel.

7. The stator according to claim 1,
wherein each of the groove walls which delimit the stator grooves is insulated with a groove insulation.

8. An electric machine comprising:
the stator according to claim 1.

9. A motor vehicle comprising:
the electric machine according to claim 8, which is configured to drive the motor vehicle by electrical energy.
